(19) United States
(12) Patent Application Publication
(10) Pub. No.: US 2002/0131131 A1
(43) Pub. Date: Sep. 19, 2002

(54) Optical communication system using L-band wavelengths

(76) Inventors: Jonathan A. Nagel, Brooklyn, NY (US); Sergey Y. Ten, Horseheads, NY (US); Carl A. B. Clausen, Red Bank, NJ (US)

Correspondence Address: John P. Maldjian, Senior Patent and Trademark Counsel, TyCom (US) Inc., 250 Industrial Way West, Rm 2B-106, Eatontown, NJ, 07724, US

(21) Appl. No.: 09/981,364

(22) Filed: Oct. 17, 2001

Related U.S. Application Data
(60) Provisional application No. 60/276,428, filed on Mar. 16, 2001.

(51) Int. Cl. H04B 10/00; H04B 10/12

(52) U.S. Cl. 359/173; 359/154

(57) ABSTRACT

An optical communication system including a transmitter, an optical information channel, and a receiver. The transmitter is configured to transmit a plurality of optical signals in L-band wavelengths or between about 1560 nm and about 1630 nm. Use of the L-band in long-haul optical systems permits transmission over at least about 2,000 kilometers from an originating light source such as a transmitter or another regenerator. A method of modulating and transmitting data signals in the L-band is also provided.

### CROSS-REFERENCE TO RELATED APPLICATIONS

The present application claims the benefit of the filing date of U.S. Provisional Application No. 60/276,428 filed Mar. 16, 2001, the teachings of which are incorporated herein by reference.

### FIELD OF THE INVENTION

This invention relates to optical communication networks, and in particular to the use of L-band wavelengths for optical transmission.

### BACKGROUND OF THE INVENTION

Long-haul communication networks are designed to carry information over relatively long distances, typically in the range of 600-10,000 kilometers. Examples of long-haul communication systems include terrestrial systems that carry signals, for example from coast to coast, and “undersea” or “submarine” systems that carry signals, for example, from one continent to another. These systems are typically optical systems in view of their capacity and reliability advantages.

Optical communication signals inevitably suffer from signal degradation between associated transmitters and receivers. The degradation is exacerbated by the large transmission distances in long-haul systems. Signal degradation is due to a number of factors including attenuation, noise, dispersion, etc. In an effort to minimize the affects of signal degradation, typical long-haul communication systems operate in a range of conventional wavelengths, i.e., C-band, from about 1525 nm to about 1560 nm. Contributing to the utilization of C-band has been the availability of erbium doped fiber amplifiers (EDFAs) and the relatively low loss characteristics of silica fiber at those wavelengths.

Despite the success of C-band systems, system reach, as defined by the maximum achievable distance between transmitter and receiver, is limited by nonlinear effects and noise buildup depending on fiber type and amplifier spacing. Any system configuration for increasing distance between transmitter and receiver would result in improved system reliability and cost.

Accordingly there is a need for an optical communication system that overcomes the deficiencies of the prior art to allow an increase in regenerator spacing limitations.

### SUMMARY OF THE INVENTION

An optical communication system consistent with the invention includes a transmitter configured to transmit a plurality of optical signals over an optical information channel, each of the signals being at an associated wavelength in a range from about 1560 nm to about 1630 nm, and a receiver to receive each of the signals. Advantageously, an optical communication system consistent with the invention is well suited for long-haul applications because it allows transmission over a distance in excess of 2,000 kilometers between transmitter and receiver

A combination of several factors contributes to improved performance through use of L-band wavelengths. These factors include: 1) most optical fibers exhibit their lowest loss levels in L-band wavelengths; 2) EDFAs are available for amplifying L-band wavelengths and recent improvements enable them to have flat gain characteristics and a low noise figure; 3) Raman amplification is available and allows a lower noise figure (NF) with less variability in L-band wavelengths than in C-band wavelengths; and 4) use of L-band wavelengths helps reduce nonlinear effects in the vast majority of manufactured fibers.

A method of transmitting a plurality of data signals on an optical information channel consistent with the invention includes modulating each of the data signals onto an associated wavelength in a range between about 1560 nm and about 1630 nm, and transmitting each of the wavelengths on the optical information channel.

### BRIEF DESCRIPTION OF THE DRAWINGS

For a better understanding of the present invention, together with other objects, features and advantages, reference should be made to the following detailed description which should be read in conjunction with the following figures wherein like numerals represent like parts:

FIG. 1 is a block diagram of an exemplary optical communication system consistent with the present invention;

FIG. 2 is plot of attenuation versus wavelength for a conventional silica-based optical transmission fiber;

FIG. 3 is a plot of the effective noise figure (NF) versus Raman gain at a low, moderate, and high Raman attenuation; and

FIG. 4 is a plot of spectral power density versus wavelength for an exemplary L-band Raman amplifier with a primary and secondary pump.

### DETAILED DESCRIPTION

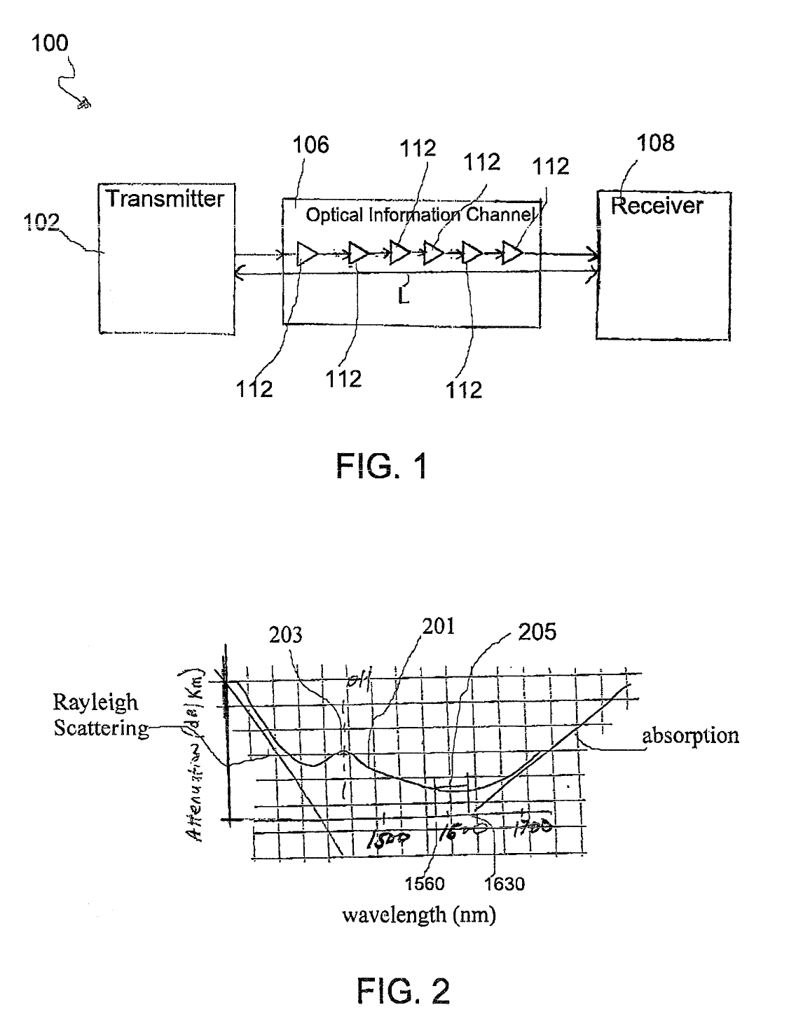

Turning to FIG. 1, there is illustrated an exemplary long-haul optical communication system 100 consistent with the invention. Those skilled in the art will recognize that the system 100 has been depicted as a highly simplified point-to-point system for ease of explanation. It is to be understood that the present invention is not limited to any specific network configuration.

The long-haul optical communication system 100 includes a transmitter 102 and a receiver 108 connected via an optical information channel 106. At the transmitter, data may be modulated on a plurality of optical wavelengths for transmission over the optical information channel 106. Depending on system characteristics and requirements, the optical information channel 106 may include an optical fiber waveguide, optical amplifiers 112, optical filters, dispersion compensating modules, and other active and passive components. A variety of configurations for each of these elements will be known to those skilled in the art. For clarity, only optical amplifiers 112 are illustrated in FIG. 1. In addition, several optical amplifiers 112 are illustrated in the exemplary system. However, any number of optical amplifiers may be utilized depending on the particulars of the communication system without departing from the scope of the present invention.

Those skilled in the art will recognize that optical amplifiers 112 amplify an input optical signal without converting it into electrical form. In contrast, the receiver 108 converts the optical signal into electrical form order to amplify, reshape, and retime the optical signal. Amplification, reshaping and retiming, also known as regeneration, is necessary to overcome transmission degradations. Regenerators, although often necessary in long-haul system, are expensive to construct, install, and maintain. Hence, the ability to reduce the number of regenerators in a long-haul communication system will serve to improve system reliability and cost.

The optical amplifiers 112 may be rare earth doped fibers such as EDFAs, semiconductor amplifiers, or Raman amplifiers. An EDFA operates by passing an optical signal through an erbium-doped fiber segment, and “pumping” the segment with light from another laser, thereby strengthening the optical signal without optical-to-electrical conversion. Those skilled in the art will recognize that Raman amplification involves pumping the transmission fiber at selected wavelengths to cause Stimulated Raman Scattering. WDM systems may require several pump wavelengths in order to achieve consistent Raman amplification over a range of wavelengths.

Advantageously, the optical communication system 100 facilitates communication on a range of long wavelengths, i.e., L-band wavelengths, from about 1560 nm to about 1630 nm. Use of L-band enables each transmitter 102 and receiver 108 to be spaced a length L apart of at least 2,000 kilometers from an origin point, e.g., the transmitter or a previous regenerator. This significantly reduces the cost and complexity of the system.

A combination of several factors contributes to improved performance through use of L-band wavelengths. These factors include: 1) most optical fibers exhibit their lowest loss levels in L-band wavelengths; 2) EDFAs are available for amplifying L-band wavelengths and recent improvements enable them to have flat gain characteristics and a low noise figure; 3) Raman amplification is available and allows a lower noise figure (NF) with less variability in L-band wavelengths than in C-band wavelengths; and 4) use of L-band wavelengths helps reduce nonlinear effects in the vast majority of manufactured fibers. Each factor is addressed in more detail below with reference to various figures where appropriate.

Turning to FIG. 2, a plot 201 of wavelength versus attenuation (db/km) for a conventional silica-based transmission fiber is illustrated. As shown, the lowest attenuation plateau 205 occurs between about 1560 nm and about 1630 nm for most fibers. On the short wavelength side of the plateau 205, fiber attenuation increases due to Rayleigh scattering and an OH⁻ absorption peak 203. The OH⁻ absorption peak 203 occurs when light traveling along the fiber encounters OH⁻ ions, which absorb optical energy and dissipate it as a small amount of heat. This absorption peak 203 typically occurs just below 1400 nm in silica fiber. Rayleigh scattering occurs when light scatters as it encounters local variations in the core's refractive index as it travels along the fiber and this is typically the major cause of attenuation. Rayleigh scattering has less affect on longer wavelengths than shorter wavelengths, and the effect is proportional to λ⁻⁴. Therefore, both the electric field attenuation coefficient α and the loss decrease at longer wavelengths in proportion to λ⁻⁴. On the longer wavelength side of the plateau 205, fiber attenuation increases due to absorption caused by the molecular resonance of the SiO₂ molecule. Hence, absent absorption issues at longer wavelengths, operation at longer wavelengths such as L-band wavelengths results in the lowest attenuation plateau for most fibers. As such, lower attenuation permits greater spacing between transmitters and receivers, and between optical amplifiers.

Another factor contributing to the advantages associated with use of L-band wavelengths relates to the performance of EDFAs at these wavelengths. Historically, reported performance of EDFAs in the L-band was inferior to that in the C-band. The NF had generally been 1-2 dB higher than that for the C-band, and the output power had been 1 to several dBs lower than the C-band. However, recent advancements in EDFAs have improved their performance to be at least comparable to that in the C-band.

In general, EDFAs in the L-band have a relatively low gain coefficient because L-band transitions in Erbium are outside the peaks of the upper and lower lasing states manifold. This energy level configuration results in a predictably changing gain curve over L-band wavelengths that can be effectively flattened with filters. A typical gain shape curve is much higher in the C-band then in the L-band, which would appear to cause a much higher gain in the C-band than the L-band. However, in practical operation, amplified spontaneous emission (ASE) in the C-band drives a substantial amount of ions into the ground state thereby reducing the effective gain and increasing the NF in C-band.

In addition, those skilled in the art will recognize that in order to achieve a low NF in an EDFA, substantially all ions must be in the excited state to create an effectively high inversion gain shape. Such an inversion gain shape is created in the L-band compared to the C-band because the lower lasing manifold state is less populated than that for the C-band transitions. The result is a relatively low NF for L-band EDFAs.

Yet another factor contributing to improved performance in the L-band is the availability of Raman amplification with a lower NF with less variability than in the C-band and distributed gain over L-band wavelengths. Raman amplification may be used alone or in conjunction with other amplifiers such as EDFAs. Those skilled in the art will recognize that Raman amplification occurs throughout the optical transmission fiber when the fiber is pumped at an appropriate wavelength or wavelengths. Gain is achieved at a wavelength that is longer than the pumped wavelength through the process of Stimulated Raman Scattering. The pumping energy may be provided by a variety of means, e.g., from a laser pump source. The difference between the pumped wavelength and the associated amplified wavelength spectrum at the longer wavelength is referred to as a “Stokes shift.” The Stokes shift for a typical silica fiber is approximately 13 THz.

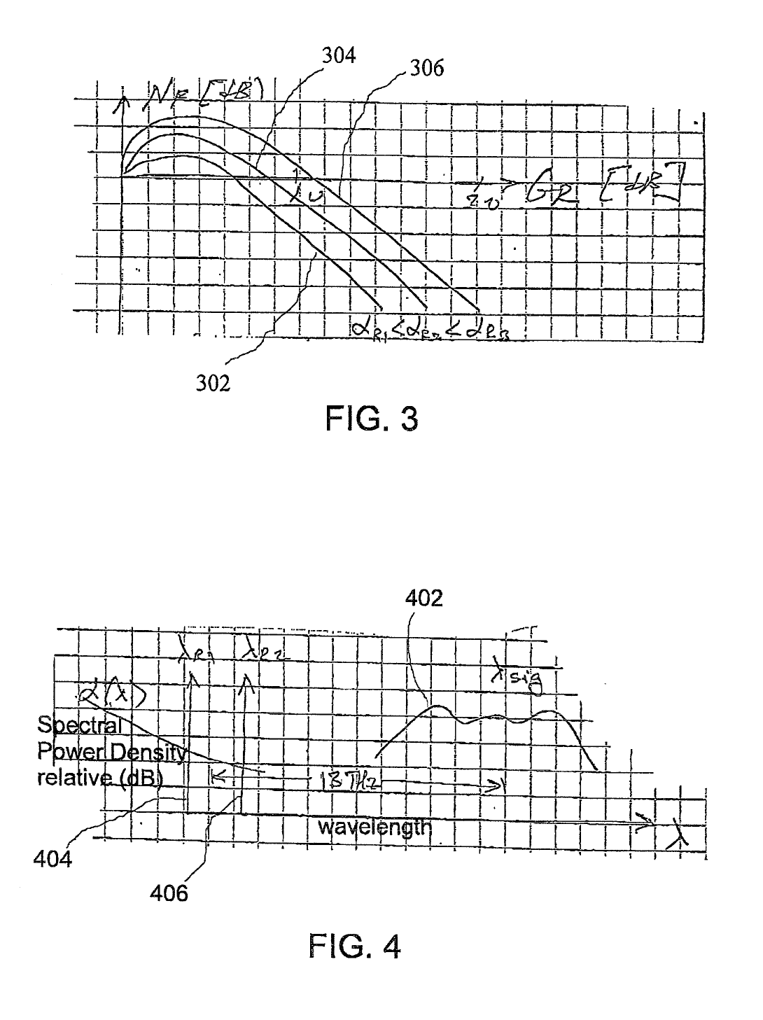

Ideally, as illustrated in FIG. 3, the pumping wavelength is one where attenuation is lower because the NF is lower for an equivalent gain level. FIG. 3 illustrates three curves 302, 304, and 306 at lower, moderate, and higher relative Raman attenuation. For instance, the lower Raman attenuation curve 302 with attenuation coefficientα_{R1} has a lower NF than the moderate Raman attenuation curve 304 with attenuation coefficient α_{R2} at an equivalent gain level G_{R}. Similarly, the moderate attenuation curve 304 has a lower NF than the higher attenuation curve 306 at an equivalent gain.

Advantageously, the pumping wavelength for a pumping laser to provide gain in L-band wavelengths is in the 1500 nm range, e.g. from about 1480 nm to about 1520 nm. At this pump wavelength, attenuation is lower than most other wavelengths, including those pumping wavelengths typically used to amplify signals in the C-band, which may be in the 1425 nm-1480 nm range. This allows Raman amplification in the L-band to be accomplished at a very low NF compared to C-band amplification. In addition, Raman pumps capable of generating 200 mw are readily available in this 1500 nm range.

Turning to FIG. 4, the effects of an exemplary pumping scheme for Raman amplification with two pumps is illustrated. The use of multiple pumps allows gain to be more evenly distributed over L-band wavelengths. Those skilled in the art will recognize that any number of pumps may be utilized. For example, a primary pump 404 is configured to pump the transmission fiber at a wavelength λ_{R1}. In addition, a secondary pump 406 is configured to pump the fiber at a longer wavelength λ_{R2}. The two pumps produce a combined gain characteristic 402 over a range of longer wavelengths. Again, the pumping wavelengths are advantageously around 1500 nm given an approximate 13 THz Stokes shift for silica fiber.

Finally, use of L-band also helps to reduce nonlinear effects. As WDM systems utilize higher and higher bit rates, the amount of optical power within fibers is increasing. At high optical power, nonlinear effects are increasingly noticeable. There are two primary categories of nonlinear effects, Kerr effects and scattering effects. Kerr effects such as self phase modulation, cross phase modulation, and four wave mixing, may occur because the refractive index of the core changes depending on the intensity of light traveling within the core. Use of L-band wavelengths helps to reduce such nonlinear effects that can occur at higher optical power levels because the fiber effective area is larger at longer wavelengths. In addition, fiber dispersion for advanced NZ-DSF fibers is larger in L-band wavelengths and further reduces the nonlinear impairments. The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention.

What is claimed is:

1. An optical communication system comprising:
a transmitter configured to transmit a plurality of optical signals over an optical information channel, each of said signals being at an associated wavelength in a range from about 1560 nm to about 1630 nm; and
a receiver configured to receive said plurality of optical signals.

2. A system according to claim 1, wherein said optical information channel comprises at least one optical amplifier configured to amplify said range of wavelengths.

3. A system according to claim 2, wherein said optical amplifier is a Raman amplifier pumped at a wavelength between about 1480 nm and about 1520 nm.

4. A system according to claim 2, wherein said optical amplifier is an erbium doped fiber amplifier.

5. A system according to claim 1, wherein said optical information channel spans at least 2,000 km between said transmitter and said receiver.

6. An optical communication system comprising:
a transmitter configured to transmit a plurality of optical signals over an optical information channel, each of said signals being at an associated wavelength in a range from about 1560 nm to about 1630 nm, said optical information channel comprising at least one optical amplifier configured to amplify said range of wavelengths; and
a receiver configured to receive said plurality of optical signals,
said optical information channel spanning at least 2,000 km between said transmitter and said receiver.

7. A system according to claim 6, wherein said optical amplifier is a Raman amplifier pumped at a wavelength between about 1480 nm and about 1520 nm.

8. A system according to claim 6, wherein said optical amplifier is an erbium doped fiber amplifier.

9. A method of transmitting a plurality of data signals on an optical information channel comprising:
modulating each of said data signals onto an associated wavelength in a range between about 1560 nm and about 1630 nm, and
transmitting each said wavelength on said optical information channel.

10. The method of claim 9 further comprising:
regenerating said data signals after said data signals travel at least 2,000 km from a transmitter.
